(19) United States
(12) Patent Application Publication
(10) Pub. No.: US 2007/0102293 A1
(43) Pub. Date: May 10, 2007

(54) Electrochemical flow cell, an assembly of and a method of fabrication of the same

(76) Inventors: Yu-Chong Tai, Pasadena, CA (US); Jun Xie, Foster City, CA (US); Darron K. Young, San Gabriel, CA (US)

Correspondence Address: Daniel L. Dawes;MYERS DAWES ANDRAS & SHERMAN LLP, Suite 1150, 19900 MacArthur Boulevard, Irvine, CA, 92612, US

(21) Appl. No.: 11/517,123

(22) Filed: Sep. 6, 2006

Related U.S. Application Data
(60) Provisional application No. 60/715,354, filed on Sep. 7, 2005.

(51) Int. Cl. G01N 27/26

(52) U.S. Cl. 204/409

(57) ABSTRACT

An electrochemical flow cell comprises a substrate having an insulated surface, a polymer gasket integrally disposed on the surface, and a top cover disposed on the gasket. The components define a fluidic channel when assembled. An electrode(s) on the substrate surface provides for electrochemical detection of analytes in the fluid flowing over the electrode in the fluidic channel. The electrode(s) can be also integrated to the substrate. The assembly can be packaged. The flow cell inexpensive, versatile, and disposable. Small dimensions can facilitate good sensitivity and selectivity. Applications include environmental, life sciences, pharmaceuticals, and proteomics. The cell can be adapted for both detector and electrospray ionization applications.

### RELATED APPLICATIONS

The present application is related to U.S. Provisional Patent Application Ser. No. 60/715,354, filed on Sep. 9, 2005, which is incorporated herein by reference and to which priority is claimed pursuant to 35 USC 119.

### BACKGROUND OF THE INVENTION

1. Field of the Invention

The invention relates to the field of microfluidic, electrochemical flow cells and their fabrication.

2. Description of the Prior Art

Conventional micromachining and surface micromachining which can be used in the practice of electrochemical flow cells include, for example, (1) M. Madou, Fundamentals of Microfabrication, 2nd Ed., 2002, which describes for example, (2) Koch et al., Microfluidics Technology and Applications, 2000, (3) Van Zant, Microchip Fabrication, 5th Ed., 2004, (4) Lacourse, Pulsed Electrochemical Detection in High-Performance Liquid Chromatography, 1997, (5) “Integrated Parylene LC-ESI on a Chip,” Thesis by Jun Xie, Ph.D., California Institute of Technology, 2005, (6) Bard et al., Electrochemical Methods: Fundamentals and Applications, 2nd ed., Wiley, 2001, (7) Meyer, Practical High-Performance Liquid Chromatography, 3rd Ed., Wiley, 1998, (8) Acworth et al., “An Introduction to HPLC-Based Electrochemical Detection: from Single Electrode to Multi- Electrode Arrays.” In Progress in HPLC, Vol. 6. Acworth, I. N., et al. (Eds), 1996.

Conventional liquid chromatography developments and applications are described in, for example, Harris, Analytical Chemistry, Feb. 1, 2003 , 65A-69A (“Shrinking the LC Landscape”).

Small scale chromatography systems and applications and electrochemical flow cells are generally known in the art and commercially available. For example, electrochemical flow cells are described in, for example, U.S. Pat. Nos. 4,413,505 and 4,552,013 to Matson, and U.S. Pat. No. 6,783,645 to Cheng noted above, each of which are incorporated herein by reference. Electrochemical flow cells can be used as detectors. In contrast, U.S. Pat. No. 6,784,439 incorporated herein by reference describes flow through electrospray ionization devices which require high voltage electrodes. In addition, the '439 patent describes electrodes and gaskets which are engineered to be removed from the substrate. They are not integrated with their supporting substrate. Electrochemical flow cells are also described in, for example, U.S. Provisional Application Ser. No. ______ filed Jun. 17, 2005, to Xie et al. “On-Chip Electrochemical Flow Cell” including electrode geometry, flow modeling, and microfabrication methods, which is hereby incorporated by reference in its entirety. The electrochemical flow cell can be engineered to provide the best selectivity and sensitivity for a given application. Multiple forms of electrochemical detection can be used including conductivity, dc amperometry, integrated amperometry, pulsed amperometry, and coulometry.

Electrochemical flow cells can be important in, for example, environmental studies and proteomic analysis. Electrochemical flow cells can be used as detectors for a variety of separation methods such as capillary electrophoresis and chromatography, including liquid chromatography, ion chromatography, and HPLC. Also, they can be used in electrospray ionization mass spectral (ESI-MS) applications.

In general, a need exists to miniaturize separation and bioanalytical methods including proteomics and environmental research. Many of the electrochemical flow cell commercially available on the market, in general, comprise a gasket which defines a fluidic channel and an electrode (e.g. a working electrode) which is exposed to the fluidic channel and in contact with a fluid inside the fluidic channel. In many cases, the electrode is a metal wire embedded inside a plastic block with the tip of the wire exposed to the fluidic channel. This type of electrode needs routine cleaning and polishing which can be labor intensive, time consuming, and unreliable.

U.S. Pat. No. 6,783,645 (Cheng et. al.) provides another approach. It describes how to construct a metal disposable, working electrode on a polymer substrate using sputtering. Due to the mass production capability of the thin film process, a disposable working electrode structure can be manufactured. However, the devices disclosed in U.S. Pat. No. 6,783,645 need a careful alignment of the plastic gasket and the working electrode structure. This can be a problem, in particular, when the gasket is very thin (e.g. less than 25 μm). Gasket thickness is important because flow cell volume is directly related to gasket thickness. To achieve small flow cell volume, the gasket needs to carefully machined, which adds more complexity in dealing with thin material.

Hence, improved approaches are needed. For example, better cost-effective, disposable systems are needed which also provide good performance. Better versatility and combination of properties are needed.

### BRIEF SUMMARY OF THE INVENTION

The illustrated embodiments are an electrochemical flow cell device or assembly and methods of making and using the same. Larger systems and applications are also described. The illustrated embodiments can be used and adapted for both detector and ESI applications. In preferred embodiments, an alternative design and method is provided to make a disposable electrode on a substrate that has an integrated thin polymer gasket. The present electrochemical flow cells do not require high voltage electrodes or high voltage power supplies when used as a detector. The present electrochemical flow cells can be engineered for detection, if desired, rather than for electrospray ionization. Microfabrication generally makes it easier to fabricate a very thin gasket (e.g. less than 50 μm). Because the gasket is integrated on the same substrate where the electrodes are deposited, alignment and handling become simple and reliable.

Another important advantage is that precise dimensions can be achieved because of microfabrication. For example, the flow channel that is defined by the gasket can be in a range between about 10 microns to about 1,000 microns wide. This leads to a small volume flow cell design which is desirable for small flow rate analysis, such as capillary LC or nano LC.

One embodiment provides an electrochemical flow cell comprising: a substrate comprising an electrically insulated surface; a polymer gasket integrally disposed on the electrically insulated surface; a cover comprising a fluidic inlet and a fluidic outlet, the cover being disposed on the polymer gasket; wherein the electrically insulated surface, the polymer gasket, and the cover form a fluidic channel, and the inlet and the outlet are fluidly coupled to the fluidic channel; and at least one electrode disposed on the insulated surface, wherein the electrode is at least partially exposed to the fluidic channel.

The cell can comprise a plurality of electrodes exposed to the fluidic channel. The electrode can be integrated with or integrally disposed on the substrate surface. The cover can be removably secured to the polymer gasket. The substrate can comprise, for example, silicon, glass, quartz, an organic polymer, or a combination thereof.

The insulated surface can comprise, for example, silicon oxide, silicon nitride, parylene, polyimide, fluorinated polymer, Teflon®, or a combination thereof. The polymer gasket can comprise, for example, parylene, polyimide, fluorinated polymer, Teflon®, polycarbonate, polyolefin, polymethylmethacrylate (PMMA), polyester, or a combination thereof. In particular, the polymer gasket can comprise parylene or polyimide or Teflon®.

The gasket can have a thickness, for example, between about 0.1 microns to about 100 microns. More particularly, the gasket can have a thickness between about 1 micron to about 25 microns. The fluidic channel can have a width, for example, between about 10 microns to about 1,000 microns.

The electrode or plurality of electrodes can comprise metals such as, for example, gold, platinum, palladium, copper, silver, titanium, chromium, aluminum, tungsten, carbon, carbonaceous material, or a combination thereof. The electrode or the plurality of electrodes can have a thickness between about 10 nm and about 5000 nm, or about 10 nm to about 1,000 nm. The cover can be a polymeric cover; the cover can be a plastic cover.

In one embodiment, the substrate is silicon, the insulated surface is silicon oxide, the cover is a plastic cover (such as PEEK), the polymer gasket comprises parylene, and the electrodes are metal electrodes. In this embodiment, the flow cell is made so that the fluidic channel has a channel width of about 10 microns to about 1,000 microns, and the electrodes have a thickness of about 10 nm to about 1,000 nm, and the gasket has a thickness of about 1 micron to about 25 microns.

Also provided are cells further assembled with packaging. Additional components are used to hold the components together to provide seal and avoid leaks despite pressurization. Another embodiment provides a disposable electrochemical flow cell comprising: (i) a substrate comprising an insulated surface; (ii) a gasket integrally disposed on the electrically insulated surface; (iii) a cover comprising a fluidic inlet and a fluidic outlet, the cover being removably secured on the gasket; wherein the insulated surface, the gasket, and the cover form a fluidic channel, and the inlet and the outlet are fluidly coupled to the fluidic channel; and at least one electrode integrally disposed on the insulated surface, wherein the electrode is at least partially exposed to the fluidic channel.

Another embodiment provides an electrochemical flow cell comprising: (A) a substrate comprising an electrically insulated surface, (B) an electrode or a plurality of electrodes on the electrically insulated surface, wherein the electrode or plurality of electrodes comprises at least one working electrode, (C) a gasket integrated with the electrically insulated surface and adapted to have a cover disposed thereon, wherein the gasket has an opening defining a microchannel for a fluid flowing through the flow cell, and the opening exposes the working electrode to the fluid and is adapted to be covered by the cover disposed on the gasket. This electrochemical flow cell can then be fitted with the cover and compressed or clamped as needed to become leak free.

Another embodiment is a method of fabricating an electrochemical flow cell comprising a combination of the following steps: providing a substrate; providing an electrically insulated surface on the substrate; forming an electrode or a plurality of electrodes on the insulated surface; forming a polymer gasket on the insulting surface; providing a top cover with an inlet and an outlet; assembling the top cover, the polymer gasket, and the insulated surface to form a fluidic channel, wherein fluid coupling is provided for the inlet and the outlet to the fluidic channel, and wherein at least one of the electrodes or plurality of electrodes is exposed within the fluidic channel.

Also provided is a larger system such as, for example, a chromatography system comprising a pump, a solvent source, a sample source, a chromatographic column, a column inlet, a column outlet, and an electrochemical flow cell detector as described herein. The chromatographic system can further comprise packaging for the electrochemical flow cell detector.

Unlike the manufacturing process in U.S. Pat. No. 6,783,645, where electrode was made using shadow mask process, a variety of methods can be used to make the electrodes as described herein, such as wet etching or lift-off. This process can easily produce electrode with smaller dimensions. For example, interdigitated electrodes can be made that have about 10 micron spacing and about 10 micron width. Another important advantage is that the detector can be disposable and inexpensive. Another important advantage, at least for some embodiments, is that the fluidic channel can be formed directly without use of indirect methods such as etching away photoresist. It also provides ways to clean the electrodes during manufacturing such as by, for example, plasma cleaning.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is a diagram of a side cross sectional view in enlarged scale of one embodiment of the flow cell.

FIG. 2 is a perspective view of one embodiment of the flow cell.

FIGS. 3a-3d are diagrams illustrating the fabrication process of one embodiment.

FIG. 4 is a photograph of a fabricated device and assembly of one embodiment.

FIG. 5 is a block diagram of a chromatography system incorporating the flow cell of FIGS. 1.-4 as a detector.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

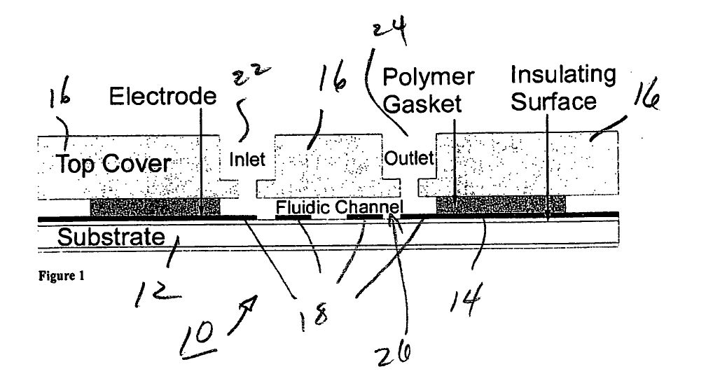

FIG. 1 is a cross sectional side view of an example of an electrochemical flow cell generally denoted by reference numeral 10. FIG. 1 illustrates a substrate 12, a polymer gasket 14, a cover 16, and an electrode 18. These components can be assembled to form an electrochemical flow cell assembly 20, which may include multiple flow cells 10 and other kinds of fluidic and electronic devices. The assembly 20 can be a flow-through electrochemical cell assembly. the components may be held in place by temporary compression using, for example, clamping methods, wing nuts, and other methods and devices known in the art. The elements may be combined to provide a sealed relationship with each other, which allows fluid to flow under pressure without leaking.

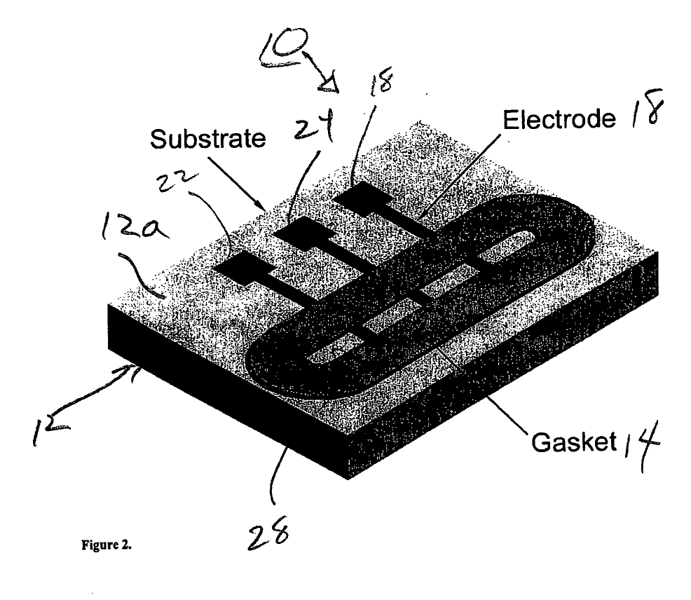

FIG. 2 is a three dimensional perspective view of an embodiment for the electrochemical flow cell 10. In particular, the illustrated embodiment provides an electrochemical flow cell 10 comprising: a substrate 12 with an electrically insulated surface 12a; a polymer gasket 14 integrally disposed on the electrically insulated surface 12a; a cover 16 having a fluidic inlet 22 and a fluidic outlet 24. The cover 16 (not shown in FIG. 2) is disposed on the polymer gasket 14. The electrically insulated surface 12a of substrate 12, the polymer gasket 14, and the cover 16 define the walls of a fluidic channel 26. The inlet 22 and the outlet 24 are fluidly communicated to the fluidic channel 26. An electrode 18 or a plurality of electrodes 18 are disposed on the insulated surface 12a with at least one of the electrode or plurality of electrodes 18 at least partially exposed to or in the fluidic channel 26.

In another embodiment the electrochemical flow cell is comprised of: (A) a substrate 12 having an electrically insulated surface 12a, and (B) an electrode 18 or a plurality of electrodes 18 on the electrically insulated surface 12a with at least one of which is a working electrode 18; (C) a gasket 14 integrated with the electrically insulated surface 12a with a cover 16 disposed thereon. The gasket 14 has an opening 28 defining a microchannel 26 for a fluid flowing through the flow cell 10. The opening 28 exposes the working electrode 18 to the fluid and is adapted to be covered by the cover 16 disposed on the gasket 14.

The cell 10 can be further fitted with the cover 16. The electrochemical flow cells 10 can be made to be disposable. They can be engineered to be used only once or for a short time before being disposed of. After manufacture and use, they generally can be engineered not to need cleaning, e.g., electrode cleaning.

Another embodiment is an disposable electrochemical flow cell 10 comprising: (i) a substrate 12 having an insulated surface 12a; (ii) a gasket 14 integrally disposed on the electrically insulated surface 12a; (iii) a cover 16 with a fluidic inlet 22 and a fluidic outlet 24. The cover 16 is removably secured on the gasket 14. The insulated surface 12a, the gasket 14, and the cover 16 define the walls a fluidic channel 26. The inlet 22 and the outlet 24 are communicated with the fluidic channel 26. At least one electrode 18 is integrally disposed on the insulated surface. The electrode 18 is at least partially exposed to or in the fluidic channel 26.

The components in a larger assembly 20 are now further described. The substrate 12 and the substrate surface 12a are not particularly limited but can comprise a variety of solid materials. The surface 12a may be planar or at least a substantially planar. The surface 12a may be insulated, particularly in the area wherein the electrode 18 is deposited. The whole surface 12a of the substrate 12 can be insulated. For example, the substrate 12 can composed of silicon, glass, quartz, an organic polymer, or a combination thereof. The insulated surface 12a can comprise, for example, silicon dioxide, silicon nitride, parylene, polyimide, fluorinated polymer, poly(tetrafluoroethylene), Teflon®, or a combination thereof.

The substrate 12 is engineered to allow the polymer gasket 14 and the electrode or plurality of electrodes 18 to be disposed on the substrate 12 surface 12a. The gasket 14 can be integrated onto the substrate 12, providing good bonding and functionally permanent fixation or adhesion to the substrate. In general, the gasket 14 can be engineered to be not removable from the substrate 12. Also, the electrode or electrodes 18 can be integrated onto the substrate 12, providing good bonding and functionally permanent fixation or adhesion to the substrate 12. In general, the electrode or electrodes 18 can be engineered to be not removable from the substrate 12.

In most cases, the gasket 14 can be a polymer gasket 14. The polymer gasket 14 is not particularly limited in the type or nature of its composition provided that it can be deposited and patterned on the substrate 12 so that it is integrated with, or integrally disposed on the substrate 12. Good bonding, fixation, or adhesion is desired. The polymer gasket 14 can be permanently coupled to the substrate 12. Good binding and adhesion between the substrate surface 12a and the gasket 14 can be achieved to form an integral structure.

The polymer gasket 14 can be a flexible gasket 14. The polymer gasket 14 can comprise, for example, synthetic polymers, including organic polymers or silicone polymers, as well as elastomeric or thermoplastic polymers. Examples include parylene, polyimide, fluorinated polymer, poly(tetrafluoroethylene), Teflon®, polycarbonate, polyolefin, poly(methy1methacrylate), and polyester. Other examples include perfluoroelastomer, Kalrez®, nylon, polyetherimide, and photoresist. Parylene, poly(para-xylylene) is the generic name for a unique family of thermoplastic polymers that are deposited by using the dimer of para-xylylene. Parylene deposition can be carried out by at lower temperatures including room temperature and by chemical vapor deposition (CVD). The thickness of the polymer gasket 14 is not particularly limited but can be, for example, about 0.1 microns to about 100 microns, or more particularly, about 1 micron to about 25 microns, or more particularly about 1 micron to about 10 microns or 12.5 microns.

The thickness of the polymer gasket 14 also generally controls the thickness of the fluidic channel 26 although in some regions the thickness of the fluidic channel 26 in a particular plane may also include the thickness of the electrode 18 in addition to the thickness of the gasket 14 as shown diagrammatically in FIG. 1. The gasket 14 can provide an opening or cutout 28 which allows for formation of the fluidic channel 26 upon assembly.

Covers 16 including top covers or cover layers are previously known in microfluidic systems. See, for example, U.S. Pat. No. 6,756,019 which is incorporated herein by reference. The nature or composition of the cover 16 is not particularly limited but can be, for example, a plastic cover 16 including for example an engineering plastic including for example poly(ether ether ketone) (PEEK). If desired, the cover 16 can be transparent, semitransparent, or opaque. The cover 16 can comprise a fluidic inlet 22 and a fluidic outlet 24, which are openings which allow fluid to flow into and out of the fluidic channel 26 after electrochemical detection and interaction with the working electrode 18. Fluidic inlets 22 and fluidic outlets 24 per se are well known (see for example U.S. Pat. No. 6,827,095 incorporated herein by reference).

The cover 16 can be disposed on the polymer gasket 14. A good seal is generally desired. The size of the inlet 22 and outlet 24 is not particularly limited but can be, for example, 100 microns to 500 microns. The shape of the inlet 22 and outlet 24 is generally round, and they are typically mechanically machined. The cover 16 can be designed not to have a reservoir chamber for storing fluid. In general, the electrochemical flow cell 10 can be designed not to store fluid. The cover 16 can be designed to be removably or temporarily secured to the polymer gasket 14.

The electrically insulated surface 12a, the polymer gasket 14, and the cover 16 can form a fluidic channel 26 which is generally designed for fluid to flow from one point, or one end, to another point, or another end. The fluidic inlet 22 and fluidic outlet 24 for the cover 16 are in fluidic communication with the fluidic channel 26. Flow channel 26 can also be a sample flow channel. The electrodes 18 can be designed so that they at least partially are exposed to or in the fluidic channel 26. The working electrode 18 can interact with the fluid passing over the electrode 18 and allow for electrochemical detection. The shape and dimensions of the fluidic channel 26 are not particularly limited, but it can have a width of, for example, about 10 microns to about 1,000 microns, or about 100 microns to about 1,000 microns, or about 250 microns to about 750 microns. The length can be, for example, 0.5 mm to about 20 mm, or about 1 mm to about 10 mm. The height of the fluidic channel 26 is not particularly limited but can be, for example, about 0.1 microns to about 100 microns, or more particularly, about one micron to about 25 microns. The height can be an average height in that some zones within the fluidic channel 26 may have a different height because of the electrodes 18.

The fluidic channel 26 can be designed for flow of water, mixtures including water, polar organic solvents, nonpolar solvent, and generally solvents used for liquid chromatography, and other types of inorganic and organic liquids. The channel 26 can be, for example, designed to provide a substantially linear flow path over the electrode 18. The length of the fluidic channel 26 can be designed with the length and height of the electrode 18 to provide good electrochemical detection and good efficiency so that as much of the analyte as possible is detected. Diffusion effects of the analyte can be taken into account in designing these geometries.

Working, reference, and counter or auxiliary electrodes 18 are known in the art. Thin films structures can be used to provide the electrodes 18. The electrodes 18 can be generally rectangular or round in shape and connect to structures which allow for further connection with a control circuit. Voltages for the electrode 18 do not need to be high voltages as needed in, for example, an electrospray ionization system, as described in for example U.S. Pat. No. 6,784,439 to Van Berkel, incorporated herein by reference.

The electrodes 18 can be disposed directly on a flat substrate surface 12a. The substrate surface 12a does not need to comprise a recess or depression to accommodate the electrode 18. Rather, the electrode 18 can extend into the fluidic channel 26 above the substrate surface 12a. The electrodes 18 are not particularly limited but can be patterned and can comprise one or more metals, including noble metals, including, for example, gold, platinum, palladium, copper, silver, titanium, chromium, aluminum, tungsten, carbon, carbonaceous material, or combinations or alloys thereof. Carbonaceous materials can be used for the electrode 18 including, for example, carbonized parylene and photoresist. Carbon electrodes 18 can be used. Pt/Ti electrodes 18 can be used. Electrically conductive and electrochemically active materials can be used. Working electrodes 18 can be made so that electrode surface reactions are carried out on the working electrode 18.

Working electrodes 18 and counter or auxiliary electrodes 18 can be made using the same thin film layer. The electrodes 18 can have, for example, a thickness of about 10 nm to about 5,000 nm, or about 10 nm to about 1,000 nm, or about 100 nm to about one micron. Thinner electrodes 18 can help provide less blocking of flow. The electrodes 18 can be configured with an interdigitated designs. Comb-like patterns can be used for electrodes 18. (0047) Known methods and devices can be used to pass current to the electrodes 18 from external devices and to control current pulses. High voltages are not generally needed or desired in a detector embodiment. U.S. patent application Ser. No. 11/040,116 filed Jan. 24, 2005 (“Pyrolyzed Thin Film Carbon”), incorporated herein by reference, describes the formation and use of thin carbon electrodes 18. In a preferred embodiment, the electrodes 18 and the gasket 14 are well integrated with, integrally disposed on, or permanently fixed or adhered to the substrate 12.

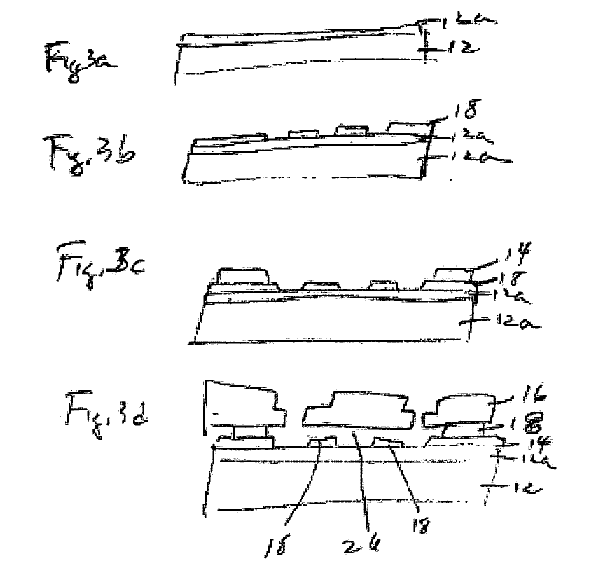

FIG. 3 is a diagram which illustrates one embodiment for making an electrochemical flow cell 10. The method comprises a combination of one or more steps of the following steps. Good bonding at the interfaces between the substrate 12 and the electrode 18 or electrodes 18, and between the substrate 12 and the gasket 14 is undertaken in each step. Substrate 12 is fabricated and/or provided and the insulative surface 12a on the substrate 12 is fabricated and/or provided as shown in FIG. 3a. The plurality of electrodes 18 or electrode 18 can be patterned on the insulative surface 12a. The electrode or electrodes 18 are integrally formed on the substrate 12 as shown in FIG. 3b. The gasket 14 is deposited and patterned as shown in FIG. 3c. The gasket 14 can be integrally formed on the substrate 12. The cover 16 is fabricated and provided. Fluidic inlets and fluidic outlets can be fabricated in the cover 16. The substrate 12, gasket 14, and the cover 16 are assembled, forming the fluidic channel 26, with the electrode 18 (or electrodes 18) ready to function as working electrode 18 in the fluidic channel 26 and interact with fluid passing over the electrode 18.

When cells 10 are simultaneously made in multiple numbers then the entire assembly is diced as desired into single cells 10 or subsets of cells 10 as assemblies 20. The assembly 20 is cleaned and packaged as needed in the application.

Consider now the fabrication methodology in greater detail. In one embodiment the method of fabricating an electrochemical flow cell 10 comprises the steps of providing a substrate 12; providing or forming an electrically insulated surface 12a on the substrate 12; forming or disposing an electrode or plurality of electrodes 18 on the insulated surface 12a; forming or disposing a polymer gasket 14 on the insulated surface 12a; providing or disposing a top cover 16 with an inlet 22 and an outlet 24. The top cover 16, the polymer gasket 14, and the insulated surface 12a are combined to form a fluidic channel 26, with which fluid communication to the fluidic channel 26 is provided from the inlet 22 and to the outlet 24. At least one of the electrodes or plurality of electrodes 18 is exposed within the fluidic channel 26.

Providing or forming the polymer gasket 14 can comprise, for example, using spin coating, vapor deposition, plasma coating, or photolithography. Providing or forming the electrode or plurality of electrodes 18 can comprise, for example, using electron beam evaporation, sputtering, electroplating, lift-off, photolithography, or chemical wet etching. Providing or forming the electrically insulated surface 12a can comprise, for example, using thermal oxidation, spin coating, or chemical vapor deposition on the substrate 12.

Another embodiment comprises a method of fabricating an electrochemical flow cell 10 comprising the steps of (A) providing a substrate 12 having an electrically insulated surface 12a, (B) depositing an electrode or a plurality of electrodes 18 on the electrically insulated surface 12a, wherein the electrode or plurality of electrodes 18 comprises at least one working electrode 18; (C) fabricating a gasket 14 on the electrically insulated surface 12a. The gasket 14 is permanently coupled to the electrically insulated surface 12a and has an opening 28 defining a microchannel for a fluid flowing through the flow cell 10. The opening 28 exposes the working electrode 18 to the fluid.

The electrochemical flow cell 10 can be and should be rugged and easy to use. It can further comprise or be part of a packaging system 30 which allows the fluid inlet 22 and outlet 24 to be coupled with external systems including the packaging system. The packaging system 30 can also provide sealing and protection for actual use. The packaging system 30 can also integrate the cell 10 with other chips or microfluidic components such as columns or detectors. For example, the packaging system 30 can provide a mechanical structure to clamp the top cover 16 and the electrode 18 together. In addition, exemplary components including pogo pins and PCBs for electrical connection and larger packaging assemblies. If desired, the system 30 can also comprise additional components such as, for example, temperature detectors, sensors, thermal sensors, controllers, flow controllers, and the like. For example, temperature detectors and controllers are described in, for example, U.S. patent application Ser. No. 11/059,625 filed Feb. 17, 2005 (“On Chip Temperature Controller Methods and Devices”) incorporated herein by reference. U.S. application Ser. No. 11/192,434 filed Jul. 29, 2005 (“Modular Microfluidic Packaging System”), incorporated herein by reference, describes examples of packaging systems. Packaging of fluidic and microfluidic systems is generally known as described in, for example, U.S. Pat. Nos. 6,548,895, 6,443,179, and 6,821,819 to Benavides et al., each of which are incorporated herein by reference.

Applications for the electrochemical flow cells 10 are numerous and generally include any application to which conventional electrochemical flow cells can be applied including analytical applications, detectors, and ESI devices. These include, for example, applications in the environment, life sciences, pharmaceutical, food beverage, chemical, petrochemical, electronics, and power industries. Applications can be those used for the Dionex ED40 and ED50 electrochemical cell 10 detectors (see U.S. Pat. No. 6,783,645 for example) incorporated herein by reference. The electrochemical flow cells 10 can be used in, for example, liquid chromatography and flow injection analysis (FIA) applications. They can be used for detection of amino acids, carbohydrates, sugars, amino sugars, amines, amino thiols, or the like. For example, phenolic compounds can be determined by employing reversed-phase separations with amperometric detection.

Nano-liquid chromatography systems are described in, for example, US Patent publication 2005/0051489 to Tai et al., published Mar. 10, 2005, which is incorporated by reference, including Pt/Ti sensing electrodes 18 and packaging and HPLC methods. Additional chromatography microfluidic chip applications are described in, for example, US Patent publication 200410124085to Tai et al., published Jul. 1, 2004, which is hereby incorporated by reference in its entirety, including electrochemical pumping and actuation of microfluidic chips and HPLC methods (see also, Xie et al., Anal. Chem., 2004, 76, 3756-3763, which is incorporated by reference). Additional chromatography components for use on a chip are described in, for example, Xie et al., US Patent Publication 2004/0253123 published Dec. 16, 2004; Xie et al. 2004/0237657 published Dec. 2, 2004; Xie et al., 2004/01 88648 published Sep. 30, 2004, each of which is incorporated by reference. An integrated chromatography system on a chip is described in, for example, U.S. patent application Ser. No. 11/177,505 filed Jul. 11, 2005 (“Integrated LC-ESI on a Chip”) incorporated by reference.

Additional chromatography applications are described in, for example, U.S. provisional application 60/671,309 filed Apr. 14,2005 to Xie et al. (“Integrated Chromatography Devices for Monitoring Analytes in Real Time”) incorporated by reference. In one application, a chromatography system 20 is provided comprising a chromatography column 34 in fluid communication with the electrochemical flow cell 10. Pumps 36 can be used including pumps on a chip. Solvent can first pass from one or more solvent reservoirs 38 and be mixed with a sample 40. Sample injectors 46 on a chip can be provided. The sample 40 can be then introduced onto the column 34 and separation achieved. Separated samples 40 can elute from the column 34 and pass into the electrochemical cell 10 which is used as the detector. Additional analysis can be carried out, if desired, using for example electrospray ionization methods (ESI). Gradient elution and reverse phase methods can be used. Separation mechanisms are not particularly limited but can be based on size, charge, hydrophobicity, specific interactions, and the like.

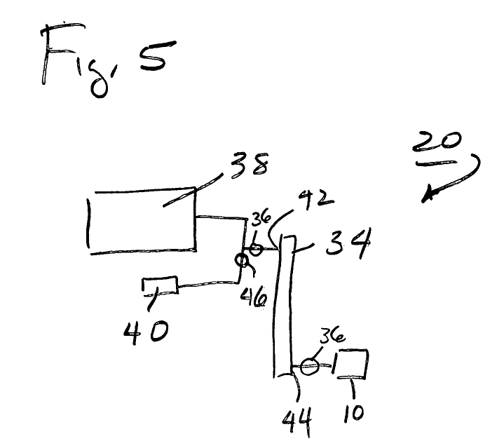

A larger system or assembly 20 can be fabricated such as, for example as shown in the block diagram of FIG. 5, a chromatography system comprising a pump 36, a solvent source 38, a sample source 40, a chromatographic column 34, a column inlet 42, a column outlet 44, and an electrochemical flow cell 10 as described above. The chromatographic system 20 can further comprises packaging for the electrochemical flow cell 10.

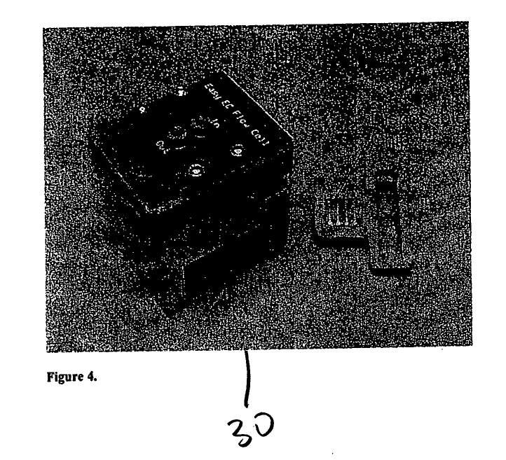

As working example, and not by way of limitation of the scope of the invention, an embodiment is shown is illustrated in FIG. 4. FIG. 4 provides a photograph of a fabricated assembly 20 made from an electrochemical flow cell 10 which was made with a PEEK top cover 16, an electrode chip made from a silicon substrate with thermal oxide, Ti/Pt electrode 18, and parylene gasket 14 deposited on it. The larger assembly 20, in addition to comprising the electrochemical flow cell 10, also includes a mechanical structure to clamp the top cover 16 and the electrode chip 18 together, and pogo pins and PCB for electrical connection with larger packaging or other components. Fluidic inlet 22 and fluidic outlet 24 were machined inside the PEEK top cover 16, so that commonly used fitting and tubing (e.g. capillary tubing from Upchurch) could be coupled to the flow cell 10. Flow channel 26 in this flow cell 10 was 500 microns wide, 6 mm long, and 10 microns high. The flow cell 10 also had a resistive temperature detector integrated on the electrode chip 18 which was a thin film metal resistor.

The process of making the electrode chip 18 started with a 4 inch silicon wafer coated with 0.5 um thermal oxide. Then two layers of photoresist (LorB from Microchem and AZ 15 18 from Clariant) were spin coated and patterned for lift-off. Before e-beam evaporation of metal, the wafer was cleaned using oxygen plasma and buffered HF dipping. 20 nm Ti and 200 nm Pt were evaporated on the chip as electrode 18. PG remover from Microchem was used to strip the lift-off photoresist away. The parylene gasket 14 was formed by a 10 μm Parylene layer. Before the parylene layer deposition, adhesion promoter (such as A-174) was applied. A 10 nm Ti and 100 nm Au layer was used deposited and patterned as etching mask for parylene patterning. Parylene etching was done in oxygen plasma. The Ti/Au etching mask was then etched away. The wafer was finally diced and cleaned in solvents (such as ST-22 stripper or acetone).

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

We claim:

1. An electrochemical flow cell comprising:
a substrate having an electrically insulated surface;
a polymer gasket integrally disposed on the electrically insulated surface;
a cover defining a fluidic inlet and a fluidic outlet, the cover being disposed on the polymer gasket, wherein the electrically insulated surface, the polymer gasket, and the cover define a fluidic channel, and the inlet and the outlet being fluidicly communicated to the fluidic channel; and
at least one electrode disposed on the insulated surface, wherein the electrode is at least partially exposed within the fluidic channel.

2. The flow cell of claim 1 wherein the substrate is comprised of silicon, glass, quartz, an organic polymer, or a combination thereof.

3. The flow cell of claim 1 wherein the insulated surface is comprised of silicon oxide, silicon nitride, parylene, polyimide, fluorinated polymer, Teflon®, or a combination thereof.

4. The flow cell of claim 1 wherein the polymer gasket is comprised of parylene, polyimide, fluorinated polymer, Teflon®, polycarbonate, polyolefin, PMMA, polyester, or a combination thereof.

5. The flow cell of claim 1 wherein the polymer gasket is comprised of parylene or polyimide or Teflon®.

6. The flow cell of claim 1 wherein the gasket has a thickness between about 0.1 micron to about 100 microns.

7. The flow cell of claim 1 wherein the gasket has a thickness between about 1 micron to about 25 microns.

8. The flow cell of claim 1 wherein the fluidic channel has a width between approximately 10 microns to 1,000 microns.

9. The flow cell of claim 1 wherein the electrode is comprised of gold, platinum, palladium, copper, silver, titanium, chromium, aluminum, tungsten, carbon, carbonaceous material, or a combination thereof.

10. The flow cell of claim 1 wherein the electrode has a thickness between about 10 nm and about 1,000 nm.

11. The flow cell of claim 1 wherein the cover is a polymeric cover.

12. The flow cell of claim 1 wherein the cover is a plastic cover.

13. The flow cell of claim 1 wherein the substrate is comprised of silicon, the insulated surface is comprised of silicon oxide, the cover is a plastic cover 6, the polymer gasket is comprised of parylene, and the electrode is a metal electrode integrally disposed on the substrate.

14. The flow cell of claim 13 wherein the fluidic channel has a channel width of about 10 microns to about 1,000 microns, the electrodes have a thickness of about 10 nm to about 1,000 nm, and the gasket has a thickness of about one micron to about 25 microns.

15. The flow cell of claim 1 the cell further comprises packaging used to assemble components.

16. The flow cell of claim 1 further comprising a plurality of electrodes integrally disposed on the substrate.

17. An electrochemical flow cell comprising:
a substrate with an electrically insulated surface;
an electrode or a plurality of electrodes integrated on the electrically insulated surface, wherein the electrode or plurality of electrodes includes at least one working electrode;
a gasket integrated with the electrically insulated surface and adapted to have a cover disposed thereon, wherein the gasket defines an opening therein defining at least in part a microchannel for a fluid flowing through the flow cell, and wherein the opening exposes the working electrode to the fluid and is adapted to be covered by the cover disposed on the gasket.

18. A method of fabricating an electrochemical flow cell comprising:
providing a substrate;
providing an electrically insulated surface on the substrate;
integrally forming an electrode or a plurality of electrodes on the insulated surface;
integrally forming a polymer gasket on the insulting surface;
providing a top cover with an inlet and an outlet defined therein;
assembling the top cover, the polymer gasket, and the insulated surface to define a fluidic channel,
wherein providing the top cover provides fluid coupling from the inlet and to the outlet with the fluidic channel, and wherein integrally forming an electrode or a plurality of electrodes exposes at least one of the electrode or plurality of electrodes within the fluidic channel.

19. The method of claim 18 wherein forming the polymer gasket comprises spin coating the gasket.

20. The flow cell of claim 1 further comprising a chromatography system comprising:
a pump;
a solvent source;
a sample source; and
a chromatographic column with a column inlet and a column outlet,
where the electrochemical flow cell is employed as a detector for the chromatography system.
